(19) United States
(12) Patent Application Publication
(10) Pub. No.: US 2014/0364180 A1
(43) Pub. Date: Dec. 11, 2014

(54) PREDATOR 80 SYSTEMS

(71) Applicant: Edward Olivar, Bellmore, NY (US)

(72) Inventor: Edward Olivar, Bellmore, NY (US)

(21) Appl. No.: 14/300,446

(22) Filed: Jun. 10, 2014

Related U.S. Application Data
(60) Provisional application No. 61/833,104, filed on Jun. 10, 2013.

(51) Int. Cl. A63F 13/20; A63F 13/00

(52) U.S. Cl. CPC A63F 13/06; A63F 13/005; A63F 2300/1062; A63F 2300/8076
USPC 463/2

(57) ABSTRACT

A video game control device is designed as a toy gun which may be compatible with a plurality of video game consoles having combat-style video games for providing video game enthusiasts with a control stick in the form of a semi-automatic rifle which compliments the game itself.

### CROSS-REFERENCE TO RELATED APPLICATION

The present application is related to and claims priority from prior provisional application Ser. No. 61/833,104, filed Jun. 10, 2013 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of video game controllers and more specifically relates to a line of video game controllers in the form of a rifle for playing shooting and combat style video games.

2. Description of the Related Art

It has been estimated that more than 50 million homes in the United States have one or more of the most popular video game systems including those manufactured by top companies such as Nintendo, Sega and Sony. Although enjoyed by consumers from all ages and walks of life, video games are particularly popular with boys and adolescents ranging in age from 8 to 16. In fact, nearly 80 percent of all households that have male children in these age groups have some sort of video game system in the home.

Few children have not been exposed to some form of video games, and access to the games is readily available in all walks of life. Not just for adolescents, American adults are increasingly playing video games and according to data released by the Interactive Digital Software Association, nearly 32 percent of Americans who enjoy computer and video games are 35 or older, with 13 percent 50 or over. In addition, 43 percent of game-players are women, with an average age of 29.

Various attempts have been made to solve the above-mentioned problems such as those found in U.S. Pub. No. 2011/0092290 to Richard D. Huebner et al, U.S. Pub No. 2010/0173686 to Danny A. Grant et al, and U.S. Pub. No. 2002/0010021 to Jack Jean McCauley. This art is representative of optical video game controllers that may comprise a gun or rifle. None of the above inventions and patents, taken either singly or in combination, is seen to describe the invention as claimed.

Ideally, a video game controller in the form of a gun or rifle should provide a realistic look and feel of a gun or rifle and have a plurality of control buttons for playing a video game, and, yet would operate reliably and be manufactured at a modest expense. Thus, a need exists for a reliable Predator 80 Systems to avoid the above-mentioned problems.

### BRIEF SUMMARY OF THE INVENTION

In view of the foregoing disadvantages inherent in the known video game control device art, the present invention provides a novel Predator 80 System. The general purpose of the present invention, which will be described subsequently in greater detail, is to provide a video game control device, designed as a toy gun, which may be compatible with video game consoles and video games to provide video game enthusiasts with a game controller that compliments the game itself.

A Predator 80 System may comprise a video game control device fabricated of plastic and may house the necessary circuits to be compatible with various video game consoles (such as Microsoft, Nintendo, Sony, and the like). In one embodiment, the game controller may be green. In alternative embodiments, the game controller may be of various colors, especially bright colors. It should be noted for safety purposes that the controller should not resemble any color related to authentic guns.

The components may comprise a stock and barrel, scope, and trigger mechanism. Power buttons may be located on the stock along with a trigger and directional controls. Additionally, relevant directional buttons may be provided along the barrel of the rifle. The device may utilize infrared light technology in conjunction with a motion sensing input device akin to video consoles available today. A motion controller may comprise an orb at the head which may glow in any of a full range of colors using RGB light-emitting diodes (LEDs). Based on the colors in the user environment captured by a camera (positioned at the tip of the Predator 80 System), the system dynamically selects an orb color that may be distinguished from the rest of the scene. The colored light may serve as an active marker, the position of which may be tracked along an image plane by the detector's eye. The uniform spherical shape and known size of the light may also allow the system to simply determine the controller's distance from the eye through the light's image size, thus enabling the controller's position to be tracked in three dimensions with high precision and accuracy.

A Predator 80 System, referred to as a video game controller system, is disclosed herein in a preferred embodiment comprising a video game controller assembly in remote communication with a video game console and an optic laser receiver unit structured and arranged to detect a relative motion of the infrared light emitted by the optic laser on a display in communication with the video game console. The video game controller assembly may comprise a controller housing having a rifle profile, an optic laser structured and arranged to emit an infrared light, a camera positioned at a tip of an orb, a video game controller processor, a wireless transmitter and receiver unit, a plurality of video game controller buttons, a joystick, a directional pad, and a power source.

The controller housing having a rifle profile may comprise a barrel, a front sight, a forearm, a rear sight, a handle comprising a plurality of curvatures for ergonomic handling of the video game controller assembly by a user, a trigger guard, a trigger, a magazine clip, a stock, and an orb. The optic laser may comprise a plurality of RGB light emitting diodes structured and arranged for emitting a full range of colors by the optic laser. The plurality of video game controller buttons may comprise a first set of game control buttons located about the handle of the controller housing and a second set of game control buttons located on the barrel of the controller housing.

The video game controller assembly and the optic laser receiver unit comprises in functional remote combination the video game controller system. The controller housing, the optic laser, the video game controller processor, the wireless transmitter and receiver unit, the plurality of video game controller buttons, the joystick, the directional pad(s), and the power source comprise in functional combination the video game controller assembly.

The barrel, the front sight, the forearm, the rear sight, the handle, the trigger guard, the trigger, the magazine clip, and the stock define the controller housing having the rifle profile. The controlling housing may have a scope for enhancing an ability of the user to aim the optic laser. The rifle profile may have a first-side, a second-side, a firing-end and a butt-end. The orb, housing the optic laser, may be located at the firing-end of the controlling housing.

The front sight may be located atop the barrel. A front-portion of the forearm may be connected to the barrel, and the rear sight may be located atop the forearm. The front sight and the rear sight work in combination to create a line of sight such that the user is able to accurately aim the video game controller assembly. As such, the line of sight may enable the user playing the video game to aim the infrared light emitted by the optic laser at a user-preferred target.

The handle may be connected to a bottom of the forearm. The magazine clip may be connected to the bottom of the forearm. The trigger guard may be connected to the bottom of the forearm and located between the handle and the magazine clip, and the trigger may be located within a hollow region of the trigger guard. Further, a rear-portion of the forearm may be connected to the stock, and the optic laser may be fixedly mounted to the barrel located at the firing-end of the controller housing.

It should be noted that the optic laser, the video game controller processor, the wireless transmitter and receiver unit, the plurality of video game controller buttons, the joystick, the directional pad, and the power source are in electric communication via a plurality of circuitry cables. The power source serves to provide operating power to the video game controller assembly. The power source may comprise at least one battery, and alternatively, may comprise a power plug which may be plugged into an electrical outlet. The optic laser may be in remote laser communication with the optic laser receiver unit. The video game controller processor and the wireless transmitter and receiver unit may be fixedly integrated within a hollow confine of the controller housing. The optic laser, the plurality of video game controller buttons, the joystick, and the directional pad are useful for controlling game functions of the video game playable on the video game console.

The video game controller assembly may further comprise a camera. The camera may be able to detect at least one color from an environment where the video game is being played by the user. Further, the camera is able to communicate the color from the environment to the video game controller processor. The video game controller processor may then be able to dynamically select a colored light from the plurality of light emitting diodes having a contrasting color as compared to the color from the environment. The orb may glow the contrasting color, which may be useful for providing an active marker such that the contrasting color is able to be tracked along an image plane by an eye of the user playing the video game. The video game controller processor may further be able to detect a uniform spherical shape and size of the contrasting color emitted by the optic laser for determining a relative distance of the video game controller assembly in relation to the optic laser receiver unit enabling a position of the video game controller assembly to be tracked in three dimensions.

It should be noted and appreciated that the video game controller system may be useful for simulating a semi-automatic weapon handling affect, improving a user-experience of playing the video game on the video game console having a combat-style theme.

The video game controller system may further comprise a kit which may include the video game controller assembly, the optic laser receiver unit, at least one connector cable, at least one power cable, and a set of user instructions. Batteries may also be included in the kit for convenience.

A method of using the video game controller system may comprise the steps of connecting the optic laser receiver unit to the video game console via the connector cable, powering the video game controller assembly via the power source, syncing the video game controller assembly with the optic laser receiver unit, and playing the video game playable on the video game console.

The present invention holds significant improvements and serves as a Predator 80 System. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Predator 80 Systems, constructed and operative according to the teachings of the present invention.

FIG. 1 shows a perspective view illustrating a Predator 80 System during an ‘in-use’ condition showing a user playing a video game using a video game controller assembly according to an embodiment of the present invention.

FIG. 2A is a perspective view illustrating the video game controller assembly comprising a controller housing having a rifle profile according to an embodiment of the present invention of FIG. 1.

FIG. 2B is a perspective view illustrating an optic laser receiver unit structured and arranged to detect an infrared light beam emitted by an optic laser of the video game controller assembly according to an embodiment of the present invention of FIG. 1.

FIG. 3A is a first-side perspective view of the video game controller assembly comprising the controller housing having the rifle profile according to an embodiment of the present invention of FIGS. 1-2.

FIG. 3B is a second-side perspective view of the video game controller assembly comprising the controller housing having the rifle profile according to an embodiment of the present invention of FIGS. 1-2.

FIG. 4 is an interior-perspective view illustrating internal components and circuitry of the video game controller assembly according to an embodiment of the present invention of FIGS. 1-3.

FIG. 5 is a flowchart illustrating a method of use for the Predator 80 System according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a Predator 80 System and more particularly to a novel video game controller having a rifle profile as used to improve the video gameplay experience of a user.

Generally speaking, a Predator 80 System may comprise a specially designed first-person shooting game controller rendered in the form of a multifaceted gun. In this manner, aficionados of such games as the immensely popular Call of Duty: Modern Warfare series may possess a piece of equipment that is designed specifically for its purpose, as opposed to playing with stock controllers that typically feature a plethora of irrelevant buttons. The Predator 80 may be sized appropriately for video game usage, similar to the type of “rifles” provided with hunting games. Thus, the video game controller of the Predator 80 System may be designed to mimic an appearance of its counterpart. The rifle components may include a stock and barrel, scope, and trigger mechanism, and other components to further simulate the look and feel of a real semi-automatic weapon. Yet, the Predator 80 System may comprise design features that set this creative product apart from the common gun controller.

The Predator 80 video game control device may be fabricated of plastic and may house the necessary circuits to be compatible with video game consoles. The components may include a stock and barrel, scope, and trigger mechanism. Power buttons may be located on the stock along with a trigger and directional controls. Additionally, relevant directional buttons may be provided along the barrel of the rifle. The device may also utilize infrared light technology in conjunction with a motion sensing input device for registering movement of the video game controller during gameplay.

The controller may comprise an orb at a head of the controller which may glow in any of a full range of colors using RGB light-emitting diodes (LEDs). Based on the colors in the user environment captured by a camera (positioned at a tip of the Predator 80 System), the system may dynamically select an orb color that may be distinguished from the rest of the scene. The colored light may serve as an active marker, the position of which may be tracked along the image plane by the detector's eye. The uniform spherical shape and known size of the light may also allow the system to simply determine the controller's distance from the eye through the light's image size, thus enabling the controller's position to be tracked in three dimensions with high precision and accuracy.

The Predator 80 System may primarily serve to provide video game enthusiasts with a vastly improved controlling unit for first-person shooting games. A fully operational controller offered in the form of a gun, the Predator 80 System may provide a new dimension of realism and excitement to the game, without requiring the user to utilize stock controllers that typically interfere with successful play. Incorporating infrared light technology, the Predator 80 System may optimize aiming accuracy, handily increasing the number of direct hits without the need to manipulate multiple buttons in order to do so. As it is designed specifically for games such as the Modern Warfare series and other combat-style video games, the Predator 80 System may add an entirely new dimension to these games by providing a realistic gun-type controller for improved gameplay.

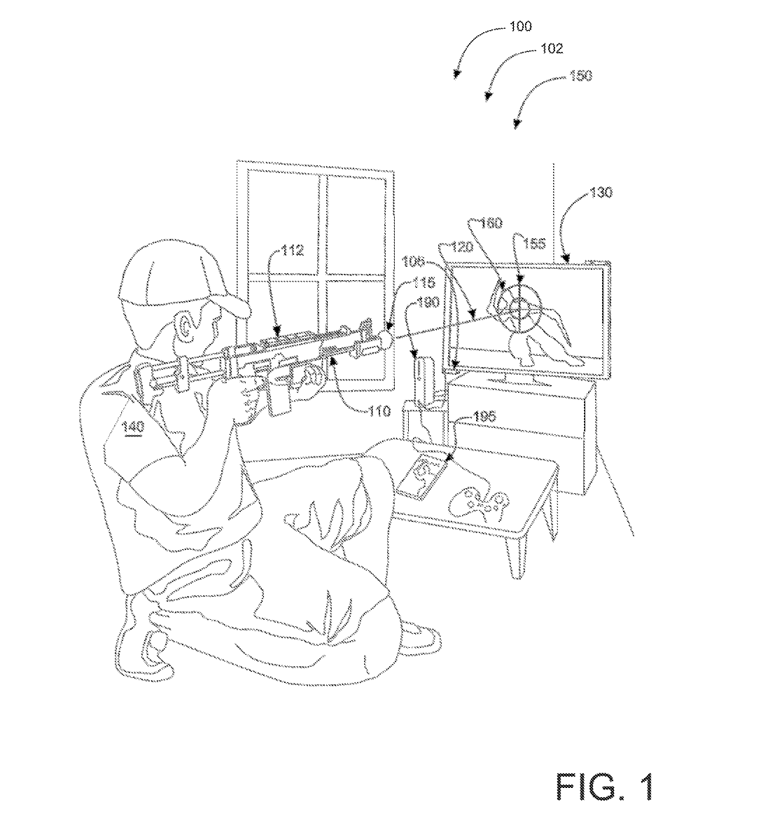

Referring to the drawings by numerals of reference there is shown in FIG. 1, a perspective view illustrating video game controller system 100 during ‘in-use’ condition 150 showing user 140 playing video game 195 using video game controller assembly 102 according to an embodiment of the present invention. As shown, video game controller system 100 may comprise video game controller assembly 102 in remote communication with video game console 190 and optic laser receiver unit 105. Video game controller assembly 102 and optic laser receiver unit 105 may comprise in functional remote combination the video game controller system 100.

In continuing to refer to FIG. 1, video game controller assembly 102 may comprise controller housing 110 having rifle profile 112, optic laser 120, video game controller processor 240, wireless transmitter and receiver unit 245, plurality of video game controller buttons 250, joystick 255, directional pad 260, and power source 280. Controller housing 110, optic laser 120, video game controller processor 240, wireless transmitter and receiver unit 245, plurality of video game controller buttons 250, joystick 255, directional pad 260, and power source 280 may comprise in functional combination video game controller assembly 102.

In still referring to FIG. 1, controller housing 110 having rifle profile 112 is shown comprising orb 115 which is preferably located at firing-end 206 of controller housing 110. Orb 115 may securely house optic laser 120. Further, orb may house plurality of light emitting diodes 410. As shown, user 140 comprising a video game player may use video game controller system 100 in conjunction with video game 195 played on video game console 190 and displayed on display 130 (such as a television). During a gameplay session of video game 195, preferably comprising a first-person shooter style game, user 140 may use video game controller system 100 having rifle profile 112 to aim at display 130. Optic laser 120 may generate active marker 155 which may be visible on display 130 such that user 140 may aim at user-preferred target 160. It should be noted and appreciated that video game controller system 100 comprises trigger 222, plurality of video game controller buttons 250, joystick(s) 255, and directional pad(s) 260 enabling user 140 to have full control while playing video game 195.

In one embodiment of the present invention, video game controller assembly 102 of video game controller system 100 may be fabricated of light-weight, durable plastic material for ease in handling. Upon reading this specification, it should be appreciated that, under appropriate circumstances, considering such issues as user preferences, design preference, structural requirements, marketing preferences, cost, available materials, technological advances, etc., other video game controller assembly 102 arrangements such as, for example, hard and soft plastics, metal, wood, etc., may be sufficient.

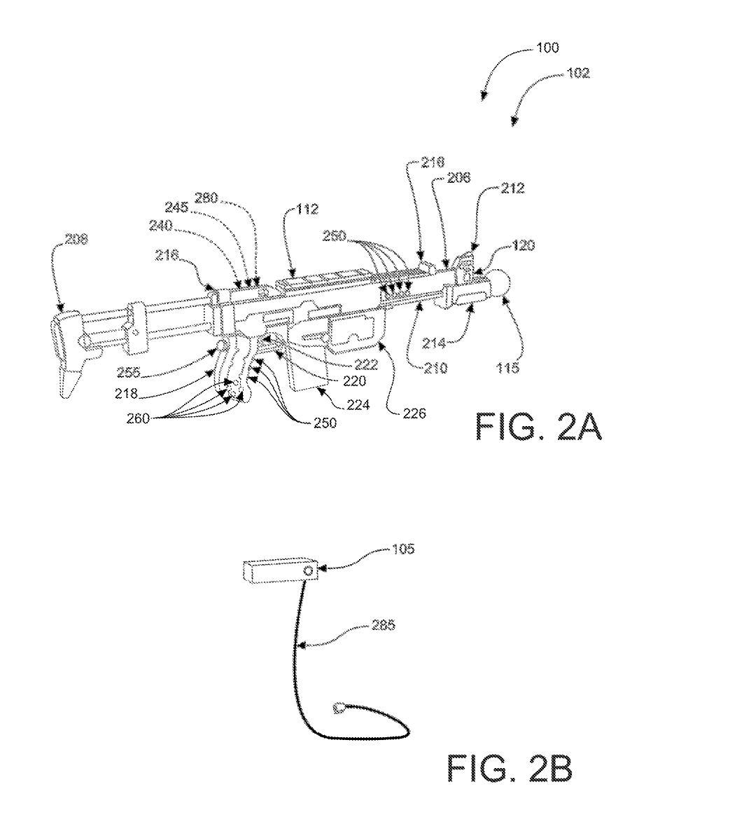

Referring now to FIG. 2A showing a perspective view illustrating video game controller assembly 102 comprising controller housing 110 having rifle profile 112 according to an embodiment of the present invention of FIG. 1. In one embodiment of the present invention, rifle profile 112 may comprise barrel 210, front sight 212, forearm 214, rear sight 216, handle 218, trigger guard 220, trigger 222, magazine clip 224, and stock 226. As such, barrel 210, front sight 212, forearm 214, rear sight 216, handle 218, trigger guard 220, trigger 222, magazine clip 224, and stock 226 may define controller housing 110 having rifle profile 112.

In continuing to refer to FIG. 2A, controller housing 110 having rifle profile 112 may comprise first-side 202, second-side 204, firing-end 206 and butt-end 208. In an embodiment of the present invention as shown, front sight 212 may be located atop barrel 210. A front-portion of forearm 214 may be connected to barrel 210. Rear sight 216 may be located atop forearm 214. Handle 218 may be connected to a bottom of forearm 214. Magazine clip 224, provided for aesthetic purposes, may be connected to the bottom of forearm 214. Trigger guard 220 may be connected to the bottom of forearm 214 and located between handle 218 and magazine clip 224. Trigger 222 may be located within a hollow region of trigger guard 220. A rear-portion of forearm 214 may be connected to stock 226. Preferably, optic laser 120 is fixedly mounted to barrel 210 and located at firing-end 206 of controller housing 110. Further, controller housing 110 having rifle profile 112 may comprise orb 115 for housing optic laser 120 and orb 115 may be located at firing-end 206 of controller housing 110.

In still referring to FIG. 2A, controller housing 110 may be fabricated of lightweight, durable plastic. Further, controller housing 110 may comprise a bright color, such as green; however, the bright color should not resemble a color scheme that is closely related to a real assault weapon.

In still referring to FIG. 2A, optic laser 120, video game controller processor 240, wireless transmitter and receiver unit 245, plurality of video game controller buttons 250, joystick 255, directional pad 260, and power source 280 are in electric communication via a plurality of circuitry cables. Power source 280 may provide operating power to video game controller assembly 102. Video game controller processor 240 and wireless transmitter and receiver unit 245 are fixedly integrated within a hollow confine of controller housing 110. It should be noted and appreciated that optic laser 120, plurality of video game controller buttons 250, joystick 255, and directional pad 260 may be useful for controlling the game function of video game 195 playable on video game console 190, and video game controller system 100 may be useful for simulating a semi-automatic weapon handling affect for improving an experience of playing video game 195 on video game console 190.

In one embodiment of the present invention, power source 280 may comprise at least one battery that is either rechargeable or non-rechargeable. In an alternative embodiment of the present invention, power source 280 may comprise a power cable that may be plugged into an electric outlet. In another alternative embodiment, power source 280 may comprise a USB cable which may be plugged into a USB compatible device, such as a smartphone or computer.

Referring now to FIG. 2B showing a perspective view illustrating optic laser receiver unit 105 structured and arranged to detect an infrared light beam emitted by optic laser 120 of video game controller assembly 102 according to an embodiment of the present invention of FIG. 1. Optic laser 120 may be in remote laser communication with optic laser receiver unit 105. Optic laser receiver unit 105 may be structured and arranged to detect a relative motion of infrared light emitted by optic laser 120 on display 130 in communication with video game console 190.

In continuing to refer to FIG. 2B, optic laser receiver unit 105 may further comprise connector cable 285. It should be appreciated that connector cable 285 may be useful for plugging optic laser receiver unit 105 into video game console 190. In such a manner, video game console 190 is able to recognize and read video game controller assembly 102.

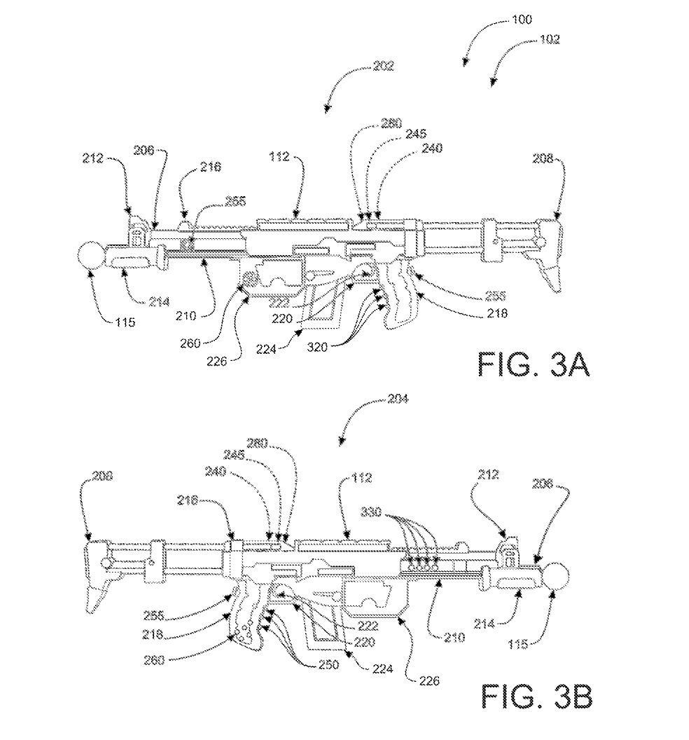

Referring now to FIG. 3A showing a perspective view of first-side 202 of video game controller assembly 102 comprising controller housing 110 having rifle profile 112 according to an embodiment of the present invention of FIGS. 1-2. As shown, controller housing 110 may comprise firing-end 206 and butt-end 208. Front sight 212 may be located atop barrel 210. A front-portion of forearm 214 may be connected to barrel 210. Rear sight 216 may be located atop forearm 214. Handle 218 may be connected to a bottom of forearm 214. Magazine clip 224, provided for aesthetic purposes, may be connected to the bottom of forearm 214. Trigger guard 220 may be connected to the bottom of forearm 214 and located between handle 218 and magazine clip 224. Trigger 222 may be located within a hollow region of trigger guard 220. A rear-portion of forearm 214 may be connected to stock 226. As further shown, optic laser 120 may be fixedly mounted to barrel 210 and located at firing-end 206 of controller housing 110. Further, controller housing 110 having rifle profile 112 may comprise orb 115 for housing optic laser 120 and orb 115 may be located at firing-end 206 of controller housing 110.

In continuing to refer to FIG. 3A, first-side 202 of video game controller assembly 102 is shown comprising first set of game control buttons 320. In one embodiment of the present invention, first set of game control buttons 320 located on handle 218 near trigger guard 220 may comprise weapon functionality buttons such as throwing frags, throwing special grenades, or aiming down. Further, it should be appreciated that trigger 222 may act as a “fire” button, thereby simulating a firing effect when squeezing trigger 222 during gameplay.

In continuing to refer to FIG. 3A, joystick 255 may be located on an opposite of first set of game control buttons 320 on handle 218. Joystick 255 may further be located on first-side 202 of video game controller assembly 102 on barrel 210. In one embodiment, joystick 255 may be useful for moving a main character during gameplay of video game 195. In another embodiment, joystick 255 may be useful for adjusting a camera angle of the gameplay of video game 195. In another embodiment, joystick 255 may be useful for adjusting a first person perspective view of the main character.

Referring now to FIG. 3B is a perspective view of second-side 204 of video game controller assembly 102 comprising controller housing 110 having rifle profile 112 according to an embodiment of the present invention of FIGS. 1-2B and 3A. As shown, second set of game control buttons 330 may be located on second-side 204 of video game controller assembly 102 on barrel 210. In one embodiment of the present invention, second set of game control buttons 330 may be useful for switching weapons, reloading a weapon, crouching, and standing/jumping.

In still referring to FIG. 3B, second-side 204 of video game controller assembly 102 comprising controller housing 110 having rifle profile 112 may comprise directional pad 260. As shown, directional pad 260 may be located on handle 218 on second-side 204 of video game controller assembly 102. Directional pad 260 may be useful for scrolling a main character left, right, up, and down. Alternatively, directional pad 260 may be useful for functioning similar to joystick 255, thereby giving user 140 a user-preferred means for manipulating the main character while playing video game 195 using video game controller assembly 102.

It should be noted and appreciated that plurality of video game controller buttons 250 comprising first set of game control buttons 320 and second set of game control buttons 330 may be useful for performing other game functionality, such as hand-to-hand combat, melee combat, running or sprinting, crawling, climbing, swimming, flying, operating a vehicle, and other functionality as may be used in first-person shooting games.

In referring to FIGS. 3A and 3B, front site 212 and rear site 216 may be useful for forming line of sight 305 for user 140 playing video game 195. Line of sight 305 may enable user 140 playing video game 195 to accurately and precisely aim infrared light emitted by optic laser 120 at user-preferred target 160 on display 130.

In continuing to refer to FIGS. 3A and 3B, controller housing 110 having rifle profile 112 may further comprise scope 310 for enhancing an ability of user 140 to aim optic laser 120.

In continuing to refer to FIGS. 3A and 3B, handle 218 of controller housing 110 may be structured and arranged comprising a plurality of curvatures for ergonomic handling of video game controller assembly 102 by user 140.

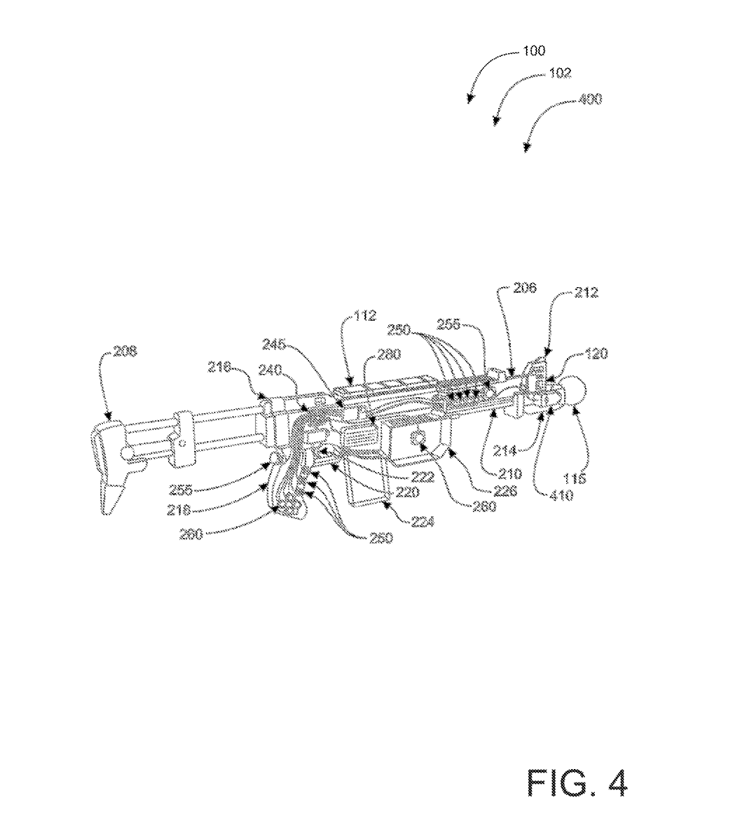

Referring now to FIG. 4 showing internal view 400 of video game controller assembly 102 according to an embodiment of the present invention of FIGS. 1-3B. As shown, video game controller assembly 102 may comprise controller housing 110 having rifle profile 112, optic laser 120, video game controller processor 240, wireless transmitter and receiver unit 245, plurality of video game controller buttons 250, joystick 255, directional pad 260, and power source 280. It should be noted that video game controller processor 240, wireless transmitter and receiver unit 245, and power source 280 may be integrated within controller housing 110.

In continuing to refer to FIG. 4, optic laser 120 may be structured and arranged to emit an infrared light. Optic laser may be powered by power source 280. Further, optic laser 120 may comprise plurality of light emitting diodes 410. Plurality of light emitting diodes 410 may be structured and arranged for emitting a full range of colors by optic laser 120.

In continuing to refer to FIG. 4, video game controller assembly 102 may further comprises camera 420 positioned on the tip of orb 115 at firing-end 206 of controller housing 110. Camera 420 may be able to detect colors from an environment of user 140 playing video game 195 and communicate colors from the environment to video game controller processor 240. Video game controller processor 240 may be able to dynamically select a colored light from plurality of light emitting diodes 410 having a contrasting color as compared to a color from the environment. It should be noted and appreciated that the contrasting color may be useful for providing active marker 155 such that the contrasting color may be able to be tracked along an image plane by an eye of user 140 playing video game 195.

Furthermore, video game controller processor 240 may be able to detect a uniform spherical shape and a size of the contrasting color emitted by optic laser 120 for determining a relative distance of video game controller assembly 102 in relation to optic laser receiver unit 105 enabling a position of video game controller assembly 102 to be tracked in three dimensions.

Video game controller system 100 may be sold as a kit comprising the following parts: video game controller assembly 102; optic laser receiver unit 105; connector cable 285; at least one power cable; and a set of user instructions. The kit has instructions such that functional relationships are detailed in relation to the structure of the invention (such that the invention can be used, maintained, or the like in a preferred manner). Video game controller system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

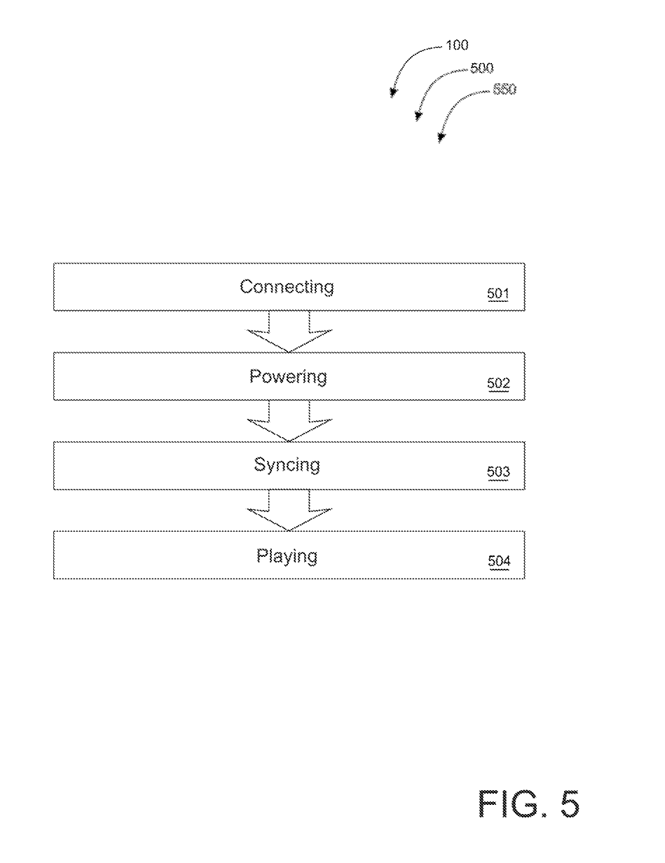

Referring now to FIG. 5, showing flowchart 550 illustrating method of use 500 for video game controller system 100 according to an embodiment of the present invention of FIGS. 1-4. As shown, method of use 500 may comprise the steps of: step one 501, connecting optic laser receiver unit 105 to video game console 190 via connector cable 285; step two 502, powering video game controller assembly 102 via power source 280; step three 503, syncing video game controller assembly 102 with optic laser receiver unit 105; and step four 504, playing video game 195 playable on video game console 190.

It should be noted that the steps described in the method of use can be carried out in many different orders according to user preference. The use of “step of” should not be interpreted as “step for”, in the claims herein and is not intended to invoke the provisions of 35 U.S.C. §112, ¶. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A video game controller system comprising:
a video game controller assembly in remote communication with a video game console, said video game controller assembly comprising;
a controller housing having a rifle profile, said rifle profile comprising;
a barrel;
a front site;
a forearm;
a rear site;
a handle;
a trigger guard;
a trigger;
a magazine clip; and
a stock;
an optic laser;
a video game controller processor;
a wireless transmitter and receiver unit;
a plurality of video game controller buttons;
at least one joystick;
at least one directional pad; and
a power source; and
an optic laser receiver unit;
wherein said video game controller assembly and said optic laser receiver unit comprise in functional remote combination said video game controller system;
wherein said controller housing, said optic laser, said video game controller processor, said wireless transmitter and receiver unit, said plurality of video game controller buttons, said at least one joystick, said at least one directional pad, and said power source comprise in functional combination said video game controller assembly;
wherein said barrel, said front site, said forearm, said rear site, said handle, said trigger guard, said trigger, said magazine clip, and said stock define said controller housing having said rifle profile;
wherein said controlling housing having said rifle profile comprises a first-side, a second-side, a firing-end and a butt-end;
wherein said front site is located atop said barrel;
wherein a front-portion of said forearm is connected to said barrel;
wherein said rear site is located atop said forearm;
wherein said handle is connected to a bottom of said forearm;
wherein said magazine clip is connected to said bottom of said forearm;
wherein said trigger guard is connected to said bottom of said forearm and located between said handle and said magazine clip;
wherein said trigger is located within a hollow region of said trigger guard;
wherein a rear-portion of said forearm is connected to said stock;
wherein said optic laser is fixedly mounted to said barrel, said optic laser located at said firing-end of said controller housing;
wherein said optic laser, said video game controller processor, said wireless transmitter and receiver unit, said plurality of video game controller buttons, said at least one joystick, said at least one directional pad, and said power source are in electric communication via a plurality of circuitry cables;
wherein said power source provides operating power to said video game controller assembly;
wherein said video game controller processor and said wireless transmitter and receiver unit are fixedly integrated within a hollow confine of said controller housing;
wherein said optic laser is in remote laser communication with said optic laser receiver unit;
wherein said optic laser, said plurality of video game controller buttons, said at least one joystick, and said at least one directional pad are useful for controlling at least one game function of at least one video game playable on said video game console; and
wherein said video game controller system is useful for simulating a semi-automatic weapon handling affect for improving an experience of playing said at least one video game on said video game console.

2. The video game controller system of claim 1 wherein said controller housing having said rifle profile comprises an orb for housing said optic laser, said orb located at said firing-end of said controlling housing.

3. The video game controller system of claim 2 wherein said optic laser is structured and arranged to emit an infrared light.

4. The video game controller system of claim 3 wherein said optic laser receiver unit is structured and arranged to detect a relative motion of said infrared light emitted by said optic laser on at least one display in communication with said video game console.

5. The video game controller system of claim 4 wherein said optic laser comprises a plurality of light emitting diodes.

6. The video game controller system of claim 5 wherein said plurality of light emitting diodes is structured and arranged for emitting a full range of colors by said optic laser.

7. The video game controller system of claim 6 wherein said video game controller assembly further comprises a camera, said camera positioned at a tip of said orb at said firing-end of said controller housing.

8. The video game controller system of claim 7 wherein said camera is able to detect at least one color from an environment of a user playing said at least one video game and communicate said at least one color from said environment to said video game controller processor.

9. The video game controller system of claim 8 wherein said video game controller processor is able to dynamically select a colored light from said plurality of light emitting diodes having a contrasting color as compared to said at least one color from said environment.

10. The video game controller system of claim 9 wherein said contrasting color is useful for providing an active marker such that said contrasting color is able to be tracked along an image plane by an eye of said user playing said at least one video game.

11. The video game controller system of claim 10 wherein said video game controller processor is able to detect a uniform spherical shape and a size of said contrasting color emitted by said optic laser for determining a relative distance of said video game controller assembly in relation to said optic laser receiver unit enabling a position of said video game controller assembly to be tracked in three dimensions.

12. The video game controller system of claim 11 wherein said front site and said rear site of said controller housing having said rifle profile are structured and arranged to create a line of site for aiming said video game controller assembly.

13. The video game controller system of claim 12 wherein said line of site enables said user playing said at least one video game is able to aim said infrared light emitted by said optic laser at a user-preferred target visible and alternatively invisible on said at least one display.

14. The video game controller system of claim 13 wherein said controller housing having said rifle profile further comprises a scope for enhancing an ability of said user to aim said optic laser.

15. The video game controller system of claim 14 wherein a first set of game control buttons of said plurality of video game controller buttons is located about said handle of said controller housing.

16. The video game controller system of claim 15 wherein a second set of game control buttons of said plurality of video game controller buttons is located on said barrel of said first-side of said controller housing.

17. The video game controller system of claim 16 wherein said handle of said controller housing is structured and arranged having a plurality of curvatures for ergonomic handling of said video game controller assembly by said user.

18. A video game controller system comprising:
a video game controller assembly in remote communication with a video game console, said video game controller assembly comprising;
a controller housing having a rifle profile, said rifle profile comprising;
a barrel;
a front site;
a forearm;
a rear site;
a handle comprising a plurality of curvatures for ergonomic handling of said video game controller assembly by a user;
a trigger guard;
a trigger;
a magazine clip;
a stock; and
an orb;
an optic laser, said optic laser structured and arranged to emit an infrared light, said optic laser comprising a plurality of light emitting diodes, said plurality of light emitting diodes structured and arranged for emitting a full range of colors by said optic laser;
a camera, said camera positioned at a tip of said orb;
a video game controller processor;
a wireless transmitter and receiver unit;
a plurality of video game controller buttons, said plurality of video game controller buttons comprising a first set of game control buttons located about said handle of said controller housing, said video game controller buttons comprising a second set of game control buttons located on said barrel of said controller housing;
at least one joystick;
at least one directional pad; and
a power source; and
an optic laser receiver unit structured and arranged to detect a relative motion of said infrared light emitted by said optic laser on at least one display in communication with said video game console;
wherein said video game controller assembly and said optic laser receiver unit comprise in functional remote combination said video game controller system;
wherein said controller housing, said optic laser, said video game controller processor, said wireless transmitter and receiver unit, said plurality of video game controller buttons, said at least one joystick, said at least one directional pad, and said power source comprise in functional combination said video game controller assembly;
wherein said barrel, said front site, said forearm, said rear site, said handle, said trigger guard, said trigger, said magazine clip, and said stock define said controller housing having said rifle profile;
wherein said controlling housing having said rifle profile comprises a first-side, a second-side, a firing-end and a butt-end;
wherein said orb housing said optic laser is located at said firing-end of said controlling housing;
wherein said front site is located atop said barrel;
wherein a front-portion of said forearm is connected to said barrel;
wherein said rear site is located atop said forearm;
wherein said front site and said rear site work in combination to create a line of site for aiming said video game controller assembly, said line of site enabling said user playing said at least one video game is able to aim said infrared light emitted by said optic laser at a user-preferred target, said controller housing further comprising a scope for enhancing an ability of said user to aim said optic laser;
wherein said handle is connected to a bottom of said forearm;
wherein said magazine clip is connected to said bottom of said forearm;
wherein said trigger guard is connected to said bottom of said forearm and located between said handle and said magazine clip;
wherein said trigger is located within a hollow region of said trigger guard;
wherein a rear-portion of said forearm is connected to said stock;
wherein said optic laser is fixedly mounted to said barrel, said optic laser located at said firing-end of said controller housing;
wherein said optic laser, said video game controller processor, said wireless transmitter and receiver unit, said plurality of video game controller buttons, said at least one joystick, said at least one directional pad, and said power source are in electric communication via a plurality of circuitry cables;
wherein said power source provides operating power to said video game controller assembly;
wherein said video game controller processor and said wireless transmitter and receiver unit are fixedly integrated within a hollow confine of said controller housing;
wherein said optic laser is in remote laser communication with said optic laser receiver unit;
wherein said optic laser, said plurality of video game controller buttons, said at least one joystick, and said at least one directional pad are useful for controlling at least one game function of at least one video game playable on said video game console;
wherein said camera is able to detect at least one color from an environment of said user playing said at least one video game and communicate said at least one color from said environment to said video game controller processor;
wherein said video game controller processor is able to dynamically select a colored light from said plurality of light emitting diodes having a contrasting color as compared to said at least one color from said environment, said contrasting color is useful for providing an active marker such that said contrasting color is able to be tracked along an image plane by an eye of said user playing said at least one video game;
wherein said video game controller processor is able to detect a uniform spherical shape and a size of said contrasting color emitted by said optic laser for determining a relative distance of said video game controller assembly in relation to said optic laser receiver unit enabling a position of said video game controller assembly to be tracked in three dimensions; and
wherein said video game controller system is useful for simulating a semi-automatic weapon handling affect for improving an experience of playing said at least one video game on said video game console.

19. The video game controller system of claim 18 further comprising a kit including:
said video game controller assembly;
said optic laser receiver unit;
at least one connector cable;
at least one power cable; and
a set of user instructions.

20. A method of using a video game controller system comprising the steps of:
connecting an optic laser receiver unit to a video game console via at least one connector cable;
powering a video game controller assembly via a power source;
syncing said video game controller assembly with said optic laser receiver unit; and
playing at least one video game playable on said video game console.
